(19) United States
(12) Patent Application Publication
(10) Pub. No.: US 2008/0096453 A1
(43) Pub. Date: Apr. 24, 2008

(54) Insulating Fiber Batt

(76) Inventor: Akiva Pinto, Jerusalem (IL)

Correspondence Address: CANTOR COLBURN, LLP, 20 Church Street, 22nd Floor, Hartford, CT, 06103, US

(21) Appl. No.: 11/659,609

(22) PCT Filed: Aug. 6, 2005
(86) PCT No.: PCT/IL05/00838

§ 371 Date: Oct. 2, 2007

(30) Foreign Application Priority Data
Aug. 6, 2004 (IL) 163402

(51) Int. Cl. B32B 5/26

(52) U.S. Cl. 442/327; 264/118

(57) ABSTRACT

The present invention provides an insulating batt of non-woven fibers. This batt is comprised of synthetic fibers, natural fibers, bonding materials or any mixture thereof. It is characterized by an axis of length, an axis of width, and an axis of thickness, wherein the extreme fibers at one end of said axis of thickness form the proximal face of the batt, and the extreme fibers at the other end of said axis of thickness form the distal face of the batt and wherein either said distal face, said proximal face or both faces are essentially non-planar faces.

### FIELD OF THE INVENTION

The present invention generally relates to the textile field. More specifically, the present invention relates to production of insulating fiber non-woven batt and the production of insulating structures thereof.

### BACKGROUND OF THE INVENTION

Cost effective, lightweight, efficient and non-toxic insulating non-woven textile batt can be produced from a mixture of fibers comprising synthetic fibers and natural fibers. Such batt can be produced in a predefined thickness and width. A batt is normally extruded from an orifice of predefined dimensions determining the width and thickness dimensions of the batt. Of these two dimensions, thickness is defined herein to be the smaller. At a given thickness and width, the length of a batt is essentially limited by the amount of fibers used to produce it. The direction of the length of the batt is herein called the machine direction. The direction of the width of the batt is herein called the cross direction. The direction of the thickness of the batt is herein called the Z direction. Once a batt is produced, it may be cut into several batt sections of partial size, and in particular partial thickness. The resulting sections can be used for insulation against heat and noise and for the prevention of condensation. Bulking or lofting material can be added to the fiber mixture to increase the bulk of the resulting batt, or to improve its insulation.

The axis of the thickness of a batt defines two faces of the batt. The face at one end is called herein the distal face, and the face at the other end is called herein the proximal face. The batt is made of fibers, which may or may not have a preferred orientation or direction. A batt made of fibers of random orientation, i.e. fibers having no preferred orientation is generally a better insulator than a batt in which most fibers are essentially parallel to some plane, but a batt made only of such fibers lacks rigidity and may crumble unless specially treated.

U.S. Pat. No. 4,837,067 Carey et al. presents non-woven thermal insulating batt comprising fibers that are substantially parallel to faces of the batt at the face portions and substantially perpendicular to the faces of the batt in the center portion of the batt.

U.S. Pat. No. 5,476,711 to Hebbard et al. presents a fiber blending system. U.S. Pat. No. 5,491,186 to Kean et al. presents a bonded insulating batt, which comprises lofting fibers.

U.S. Pat. No. 5,554,238 to English presents a method of making a resilient batt comprised of cellulosic and thermoplastic material in which two faces of the batt are heat treated. It also teaches treating a batt to increase its fire or vermin resistance.

U.S. Pat. No. 6,562,173 to Collison et al. presents a method and apparatus for forming a textile pad for laminate floor underlayment. A batt is evenly cut therein along its axis of thickness into sections of constant thickness. The mechanical properties of a baft are improved therein by coating its proximal and distal faces.

US Pat App 2002/0116793 to Schmidt presents a process and apparatus for manufacturing isotropic non-wovens.

US Pat App 2003/0021937 to Suzuki describes an insulation fiber based heat-insulating structure composed of several layers of fiber-based insulating material of essentially constant thickness stacked inbetween partition members.

It is well known in the art that air chambers within a structure improve the insulation properties of the structure. It is thus common to produce bricks having internal air chambers.

Prior art thus describes adding rigidity to textile batt by introducing coating or support materials different from the fiber batt itself. This leads to relatively complicated production methods and relatively expensive products.

Prior art thus describes even non-woven batt of constant thickness and essentially planar faces, and fails to teach formation of isolation chambers between batt when batt are superimposed onto structures.

A cost-effective non-woven textile batt and structure composed of such batt, with improved insulation and mechanical properties thus meet a long felt need.

### SUMMARY OF THE INVENTION

It is thus one embodiment of the present invention to provide an efficient insulating batt of fiber having improved mechanical properties, such as rigidity, robustness or tensile strength, while requiring neither additional coating materials nor complicated processing steps. It is in the core of the present invention to produce a multi-layered batt, wherein layers differ in isolation and mechanical properties. According to a preferred embodiment of the present invention the more rigid layers are located at the proximal and distal faces of the batt.

It is also in the core of the present invention to produce relatively more rigid layers of non-woven batt by packing fibers in a non-random direction or orientation, so that their preferred directions are parallel to the proximal and distal faces of the batt. Better insulation is provided by relatively less robust layers that are made by packing fibers in random orientation.

It is thus another embodiment of the present invention to provide an efficient insulating structure made of non-woven textile batt cut into batt sections of partial thickness, which are then superimposed to form an insulating structure, in such a manner that air chambers are formed inbetween the superimposed batt sections.

### BRIEF DESCRIPTION OF THE FIGURE

In order to understand the invention and to see how it may be implemented in practice, a preferred embodiment will now be described, by way of non-limiting example only, with reference to the accompanying drawings, in which

FIG. 1 schematically presents a batt of non-woven textile 100 as cut into a proximal section 110 and a distal section 120, and defines faces 111 and 121;

FIG. 2 schematically presents the two sections 110 and 120 as superimposed and forming a structure 200;

FIG. 3 schematically presents in cross section 10 as superimposed with a batt of non-woven textile 310 and as forming a structure 300;

FIG. 4 schematically presents in isometric view section 110 as superimposed with a batt of non-woven textile 310 and as forming a structure 300;

FIG. 5 schematically presents in isometric view section 510 cut from a batt of non-woven textile; and

FIG. 6 schematically presents in isometric view section 110 as superimposed with section 510 and as forming a structure 600;

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide an insulating batt of non-woven textile and structure.

The term ‘batt’ refers in the present invention to a textile batt that is a bonded or felted mass of fibers or a sheet of fiber wadding.

An insulating batt according to a most general embodiment of the present invention is formed of a mixture of fibers comprising either synthetic fibers, or natural fibers or both synthetic and natural fibers. Some of the fibers may be derived from plant materials such as cotton, kenaf or jute. Some of the fibers may be derived animal source, such as wool. Cellulose fibers may be derived from chopped wood or from recycled paper. The mixture of fibers can be bonded with bonding fibers such as synthetic low melt fiber, or bicomponent fiber, or with low melt synthetic powders, or with combination thereof.

The blend ratio between the bonding materials and the other parts of the mix may range from 5:95 to 50:50 percent. According to a preferred embodiment of the present invention the weight ratio is 20:80.

The batt may be chemically treated as known in the art to increase its fire or vermin resistance, for example using boric acid.

According to a preferred embodiment of the present invention the batt may be constructed from several thin webs which composition is described herein above.

A batt thus formed according to a most general embodiment of the present invention is characterized by three orthogonal directions: the machine direction, the cross direction and the thickness or Z direction, as defined hereinabove. The proximal face of the batt is the face at its proximal end, at one end of the batt along the Z direction, and the distal face of the batt is the face at its distal end, at the other end of the batt along the Z direction.

The batt according to a most general embodiment of the present invention comprises a plurality of layers stacked in parallel along the axis of thickness. Some of these are isotropic layers and some are anisotropic layers. Fibers in isotropic layers are packed into a batt in a random direction or orientation, and have no preferred orientation. An isotropic batt is relatively weak, but it is a relatively good insulator. Fibers in anisotropic layers are packed into a batt in a non-random direction or orientation, and have a preferred orientation. An anisotropic batt is relatively strong, but it is not as good an insulator as an isotropic batt. According to a most general embodiment of the present invention fibers in anisotropic layers are packed essentially in an orientation of the layer, in directions parallel to both the distal and proximal faces. Therefore, anisotropic layers are called parallel layers herein.

According to a preferred embodiment of the present invention mechanically rigid parallel layers form both proximal and distal faces of the batt.

According to a preferred embodiment of the present invention there exists an isotropic layer at the center of the batt, between the distal and proximal faces.

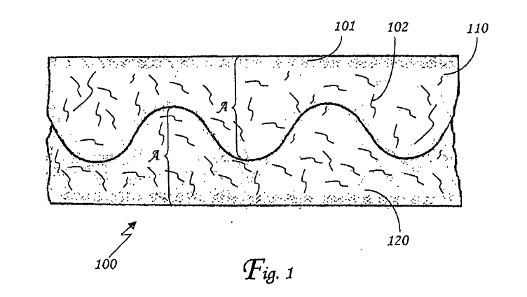

Reference is thus made now to FIG. 1, presenting a schematic and generalized presentation of a batt of non-woven textile 100 cut into a proximal section 110 and a distal section 120. The batt may be cut using a cutting implement, a steel knife, a vibrating steel saw, or any means of cutting. In a preferred embodiment of the present invention neither of the sections is of constant thickness. The thickness of batt 100 is denoted by the letter B. The thickness of sections 110 and 120 varies as a function of length, along the machine direction. The maximum thickness of section 110 is shown to be roughly equal to the maximum thickness of section 120, and this maximum thickness is denoted by the letter A. Obviously, batt 110 may be cut to produce sections of different mean thickness. In one preferred embodiment of the present invention section thickness varies as a periodic function of length, along the machine direction. In another preferred embodiment of the present invention section thickness varies as a random or pseudo-random function of length, while maintaining a minimum thickness below which mechanical stability is compromised. FIG. 1 presents a sinusoidal function. Other periodical functions would be obvious to those skilled in the art, for example saw-tooth, rectangular and square functions, or any combination thereof. Sections 110 and 120 thus each comprise an essentially non-planar face, either distal or proximal.

According to one embodiment of the present invention, variable thickness as a function of length is achieved, as the batt is moved in the machine direction, by moving the cutting implement in the Z direction. The location of the cutting implement along the Z direction as a function of time determines the resulting batt section thickness as a function of length.

According to another embodiment of the present invention multi-layered textile batt 100 comprises relatively stronger layers at its distal and proximal faces. When batt 100 is cut into sections, the distal layer becomes the distal layer of section 120, and the proximal layer becomes the proximal layer of part 110. Thus both parts comprise a strong layer, and are mechanically strong in spite of their reduced thickness.

FIG. 1 shows such an embodiment of the present invention in which batt 100 is formed mainly of a batt of fibers of isotropic orientation, and two of its faces, marked by numerals 111 and 121, both shown to be essentially planar, are formed of a batt of fibers of an orientation parallel to these faces.

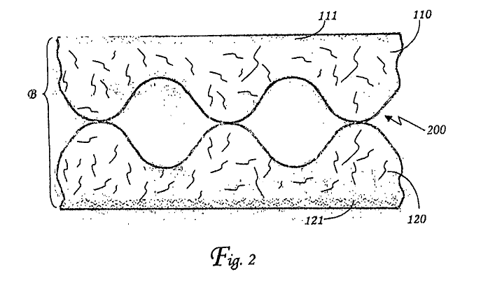

Reference is made now to FIG. 2, schematically presenting the two sections depicted in FIG. 1. Sections 110 and 120 are superimposed to form an insulation structure 200. They are not superimposed in exactly the same position in which they were cut, but displaced relative to each other. FIG. 2 depicts a preferred embodiment of the present invention in which they are displaced at a phase shift of 180 degrees or Pi radians.

FIG. 2 shows that the thickness of the structure is essentially constant, is equal to two times A, and is greater than B. Thickness A and thickness B are defined in reference to FIG. 1. The increase of thickness from a simple batt thickness B to a structure thickness two times A increases isolation properties, and is thus beneficial.

According to another embodiment of the present invention section thickness varies in a non-symmetrical function of length, for example a saw-tooth function, and the two sections may alternatively be rotated by 180 degrees relative to each other along the Z direction.

According to another embodiment of the present invention, described in reference to FIG. 1, in which both sections comprise strong layers, the resulting structure 200 comprises a proximal strong layer and a distal strong layer, and is thus mechanically robust. FIG. 2 depicts this situation, and shows how structure 200 maintains the two faces, 111 and 121, which form two faces of batt 100 in FIG. 1.

Mechanical rigidity according to the present invention does not rely on any treatment of the surface of the batt, such as heat treatment or coating. Such treatments may, however, be added to the present invention as known in the art to provide desired mechanical and resistance properties.

FIG. 2 shows how the resulting structure 200 comprises chambers inbetween sections 110 and 120. These chambers may be stuffed with a material increasing the insulation properties of the structure. According to another embodiment of the present invention the chambers are filled with gas, preferably air, it being cheap and of good thermal insulation properties.

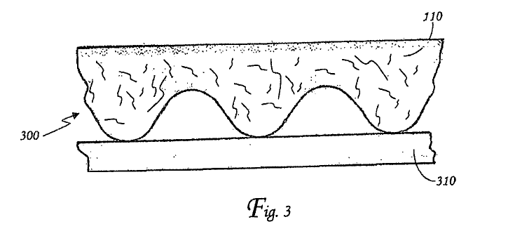

Reference is made now to FIG. 3, schematically presenting section 110 superimposed with a batt of non-woven textile 310 and forming insulating structure 300. According to another embodiment of the present invention batt 310 is a section of some other batt cut to a partial constant thickness. According to another preferred embodiment of the present invention batt 310 is a section of any other batt.

According to yet another embodiment of the present invention batt 310 is actually a batt section such as either section 110 or section 120, as described in reference to FIG. 1, rotated by 180 degrees along its machine direction.

According to another embodiment of the present invention, described in reference to FIG. 1, in which both sections comprise parallel layers, the resulting structure 300 comprises a proximal parallel layer and a distal parallel layer, and is thus mechanically robust.

FIG. 3 shows how the resulting structure 300 comprises chambers inbetween parts 110 and 310. These chambers may be stuffed with a material increasing the insulation properties of the structure, as explained in reference to FIG. 2.

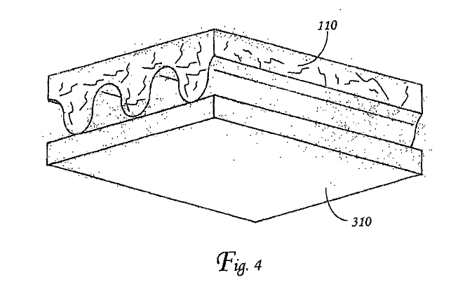

Reference is made now to FIG. 4, schematically presenting in isometric view section 110 superimposed with batt 310 and forming a structure 300, as also depicted in FIG. 3, and as described in reference to FIG. 3.

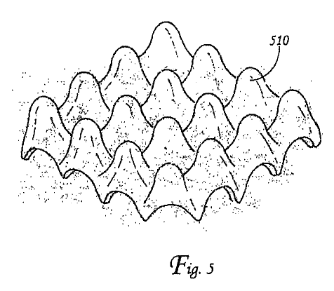

Reference is made now to FIG. 5, schematically presenting in isometric view section 510 of a batt of non-woven textile in which thickness varies as a function of both length and width. Section 510 thus comprises at least one essentially non-planar face, which is either its distal face or its proximal face. FIG. 5 depicts a sinusoidal function of both machine and cross directions, and other functions would be obvious to those skilled in the art, including periodic functions, random and pseudo-random functions, as explained in reference to FIG. 2.

According to another embodiment of the present invention, variable thickness as a function of width is achieved by using a cutting implement of the desired shape.

According to another embodiment of the present invention, variable thickness as a function of both width and length is achieved by rotating a cutting implement of a desired shape along the cross direction, while the batt advances along its machine direction.

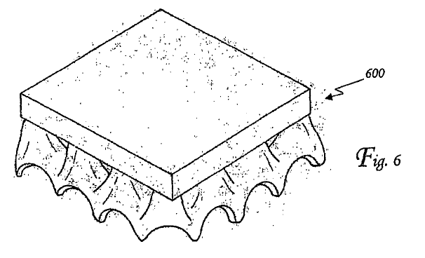

Reference is thus made now to FIG. 6, schematically presenting in isometric view section 110 superimposed with section 510 and forming a structure 600.

According to the preferred embodiment of the present invention, described in reference to FIG. 1, in which batt parts comprise strong layers, the resulting structure 600 comprises a proximal strong layer and a distal strong layer, and is thus mechanically robust.

FIG. 6 shows how the resulting structure 600 comprises chambers inbetween sections 110 and 510. These chambers may be stuffed with a material increasing the insulation properties of the structure, as explained in reference to FIG. 2.

1. An insulating batt of non-woven fibers, said batt comprising synthetic fibers, natural fibers, bonding materials or any mixture thereof; the said batt is characterized by an axis of length, an axis of width, and an axis of thickness;
wherein the extreme fibers at one end of said axis of thickness form the proximal face of the batt, and the extreme fibers at the other end of said axis of thickness form the distal face of the batt; and
wherein either said distal face, said proximal face or both faces are essentially non-planar faces.

2. The batt according to claim 1, wherein said batt comprises a plurality of layers stacked along said axis of thickness;
wherein a distal layer at one end of said axis of thickness forms said distal face, and a proximal layer at the other end of said axis of thickness forms said proximal face;

3. The batt according to claim 2, wherein said plurality of layers comprises at least one isotropic layer and at least one parallel layer;
wherein said fibers in any of said isotropic layers are packed in a random orientation;
and wherein said fibers in any of said parallel layers are packed essentially parallel to both said distal and proximal faces.

4. The batt according to claim 1, wherein said synthetic fibers are selected from low-melt synthetic fibers, polyester fibers, low-melt bicomponent fibers, polyester sheaths, polyethylene cores or any combination thereof.

5. The batt according to claim 1, wherein the ratio of said bonding material to other components of the batt by weight ranges from 5:95 to 50:50.

6. The batt according to claim 3, wherein said distal and proximal layers are parallel layers.

7. An insulating structure comprising a plurality of batts as defined in claim 1; and a plurality of chambers delimited by proximal and distal faces of said batts.

8. The structure according to claim 7, wherein a batt according to claim 3 is cut at an isotropic layer in such a manner that two batt sections are produced.

9. The structure according to claim 7, wherein said chambers are filled with gas, air or any combination thereof.

10. The batt according to claim 1, wherein the thickness of said batt is a periodic function of either said axis of length or said axis of width or both.

11. A method of producing an insulating batt structure of non-woven fiber comprising;
a. forming a master batt having essentially planar proximal and distal faces;
b. cutting said master batt into batt sections having essentially non-planar proximal or distal faces;
c. moving said batt sections relative to each other; and,
d. recombining said batt sections.

12. The method according to claim 11, additionally comprising the step of moving a cutting implement to produce a batt having an essentially non-planar face.

13. The method according to claim 11, additionally comprising at least one of the following steps of displacing the batt sections relative to each other, and of rotating said batt sections relative to each other.

14. The method according to claim 13, additionally comprising the step of chemically treating the batt to improve fire or vermin resistance.
